(19) United States
(12) Patent Application Publication
(10) Pub. No.: US 2005/0134977 A1
(43) Pub. Date: Jun. 23, 2005

(54) Image sensing device and image sensing apparatus

(76) Inventors: Yoshio Fukuda, Hino-shi (JP); Yasuo Nakajoh, Niiza-shi (JP); Junichi Ito, Fuchu-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/011,307

(22) Filed: Dec. 14, 2004

(30) Foreign Application Priority Data
Dec. 19, 2003 (JP) 2003-422872

(51) Int. Cl. G02B 5/04

(52) U.S. Cl. 359/835

(57) ABSTRACT

An image sensing device has a first prism, a second prism, a shutter mechanism, and an image sensing element. The first prism receives a luminous flux at a first incident surface, and outputs the luminous flux at a first emergent surface after having reflected the luminous flux on a first reflecting surface. The second prism receives the luminous flux at a second incident surface, which has come out from the first emergent surface, and outputs the luminous flux at a second emergent surface after having reflected the luminous flux on a second reflecting surface. The shutter mechanism is arranged between the first emergent surface and the second incident surface. The image sensing element is arranged on an image focusing surface of an optical system including the first prism and the second prism, and converts an object image into an electrical signal.

### CROSS-REFERENCE TO RELATED APPLICATIONS

This application is based upon and claims the benefit of priority from prior Japanese Patent Application No. 2003-422872, filed Dec. 19, 2003, the entire contents of which are incorporated herein by reference.

### BACKGROUND OF THE INVENTION

1. Field of the Invention

The present invention relates to an image sensing device used in a digital camera or a cellular phone with a camera and, more particularly, to an image sensing device using a prism having a free-form surface as a reflecting surface, and an image sensing apparatus using the image sensing device.

2. Description of the Related Art

A number of applications for image sensing apparatuses using a coaxial optical system have been filed as image sensing apparatuses used in digital cameras or cellular phones with a camera. In a coaxial optical system, optical elements such as a lens are rotationally symmetrical with respect to the optical axis (an axis which connects the center of the aperture of the image sensing system and the center of the image sensing screen) of the optical system. Image sensing apparatuses having a coaxial system are disclosed in, e.g., Jpn. Pat. Appln. KOKAI Publications No. 2001-272587 (reference 1) No. 2002-267928 (reference 2), and No. 2002-320122 (reference 3).

Recent digital cameras and cellular phone with a camera are required to be compact and thin and have high performance. In these devices, if the image sensing device using a coaxial optical system should be compact, the number of lenses must be decreased. However, when the number of lenses is decreased, aberrations generated in the optical system can hardly be suppressed, resulting in poor image quality. To obtain a high image quality, the number of lenses must be increased. As a result, the image sensing device becomes bulky.

As means for solving these problems, image sensing apparatus using an eccentric optical system has been proposed. Image sensing apparatuses using an image sensing optical system using a prism a free-form surface are disclosed in, e.g., Jpn. Pat. Appln. KOKAI Publications No. 11-326766 (reference 4), No. 2002-196243 (reference 5), and No. 2003-84200 (reference 6).

In the present specification, a term “eccentric optical system” means an optical system in which an optical axis of a luminous flux made incident to an optical system and an optical axis of a luminous flux emerged from this optical system do not exist coaxially. A term “free-form surface” means a curved surface which is rotationally asymmetrical to an optical axis of a luminous flux incident to the surface or an optical axis of a luminous flux emerged from the surface and which has only one mirror image plane along these optical axes.

The techniques described in references 4 to 6 aim at obtaining a compact device and a high-quality image by forming an image sensing optical system by using a prism having a free-form surface as a light incident surface, light emergent surface, or reflecting surface. Especially, in references 5 and 6, two prisms are combined. The light incident surface, reflecting surface, and light emergent surface of the first prism close to the object and the light incident surface, two reflecting surface, and the light emergent surface of the second prism close to the image sensing surface, i.e., a total of seven surfaces are formed as free-form surfaces.

The characteristic features of such an optical system are as follows.

(1) The three reflecting surfaces are formed from free-form surfaces having a power (reflecting power). These reflecting surfaces can obtain a large power and are rarely affected by chromatic aberration as compared to a refractive optical system such as a lens.

(2) The seven optical surfaces can be formed in a compact space. Hence, the optical elements are concentratedly set in the limited space.

(3) To obtain high optical performance, the optical path length of the entire optical system is preferably long to some extent. The optical path is bent by using such a prism optical system. Hence, image sensing device having a long optical path and a small outward size can be manufactured.

For these reasons, the image sensing device can be raised the quality of an image in spite of the size.

The optical system described in Jpn. Pat. Appln. KOKAI Publication No. 7-333505 (reference 7) includes a reflecting mirror, a coaxial optical system by a lens, and a reflecting mirror sequentially from the object side. As compared to this system, the optical system described in reference 5 or 6 can reduce the width. For this reason, a more compact image sensing device can be provided by using this optical system.

As electrical image sensing devices such as a digital cameras or cellular phones with a camera are prevalent, there is a demand for higher quality image sensing. The number of pixels of a CCD (Charge-coupled device) as an image sensing element for converting an object image into image data has trended to increase. Many of the CCDs with a large number of pixels are of interlace type. The interlace type CCDs read out image data by dividing it into an odd numbered field and an even numbered field.

The image data stored in these two fields cannot be read out at one time and at the same time. If the image data is sequentially read out from the two fields without light interrupting the CCD, exposure times of the odd numbered field and even numbered field become different from each other. In order to make identical the exposure times of both of the fields, it is necessary to light interrupt the CCD so as not to ensure that light is incident to another field while reading out the image data in one field. Therefore, while the image data is read out, a mechanical shutter must be provided to light interrupt the CCD.

In addition, the luminance of objects covers a wide range. If the number of pixels of the image sensing element is increased, fine graduation in one item of image data can be provided. However, under the luminance conforming to a variety of conditions, it is difficult to carry out image sensing for an optimal exposure time only with a shutter opening time and a dynamic range that the image sensing element has. In order to solve this problem, there is a need for an aperture for changing an amount of light projected to the image sensing element.

However, if coaxial optical systems disclosed in references 1 to 3 are provided with the mechanism of shutter or the aperture, the optical system become bulky in capacity, respectively. Thus, it is difficult to downsize and thin the image sensing device. On the other hand, references 4 to 6 discloses an image sensing optical system using a prism having a free-form surfaces. However, there is no reference describing specifically mounting the mechanical shutter and the aperture.

### BRIEF SUMMARY OF THE INVENTION

It is an object of the present invention to provide an image sensing device capable of downsizing the entire device and capable of acquiring a high quality image and an image sensing apparatus comprising the image sensing device.

The image sensing device according to the present invention includes a first prism, a second prism, a shutter mechanism, and an image sensing element. The first prism receives at a first incident surface a luminous flux radiated from an object, and outputs the luminous flux at a first emergent surface after reflecting the luminous flux on at least one of a first reflecting surface formed in the shape of a free-form surface. The second prism receives at a second incident surface the luminous flux emerging from the first emergent surface, and outputs the luminous flux at a second emergent surface after reflecting the luminous flux on at least one of a second reflecting surface formed in the shape of a free-form surface. The shutter mechanism is arranged between the first emergent surface and the second incident surface. The image sensing element is arranged on an image focusing surface of an optical system including the first prism and the second prism, and converts an object image formed by such an optical system into an electrical signal.

In this case, the shutter mechanism includes a shutter blade which is selectively switched to either of an open state and a closed state. In the open state, the luminous flux emerging from the first emergent surface is passed toward the second incident surface. In the closed state, the luminous flux emerging from the first emergent surface is interrupted. Alternatively, the shutter mechanism has at least two shutter blades moving together. These shutter blades are selectively switched to an open state in which the luminous flux emerging from the first emergent surface is passed toward the second incident surface and a closed state in which the luminous flux emerging from the first emergent surface is interrupted.

In addition, in order for the shutter mechanism to have an aperture function, a blade drive mechanism is provided in the shutter mechanism. This blade drive mechanism moves and holds the shutter blades in a direction which crosses the luminous flux emerging from the first emergent surface. The blade drive mechanism stops the shutter blades in a range between the closed state and the open state in order to change the size of an opening formed by the shutter blades.

In addition, in order to adjust an amount of light made incident to the image sensing element, an aperture is arranged between the first emergent surface and the second incident surface. This aperture has an opening which is smaller than an external diameter of the luminance flux emerging from the first emergent surface. In this case, in order to actuate the aperture as required, the aperture is selectively held in either of an insert position and a retracted position. At the insert position, the aperture crosses the luminous flux emerging from the first emergent surface between the first emergent surface and the second incident surface. At the retracted position, the aperture is deviated from the luminous flux. In addition, in the aperture, it is preferable to the center of the opening be arranged coaxially to a center axis of the luminance flux in the insert state. In addition, in order to reduce the bulkiness of the image sensing device, the aperture is incorporated in the shutter mechanism.

Instead of providing the aperture, a light reducing filter which reduces an amount of light may be provided between the first prism and the second prism. The light reducing filter is selectively held in either of an insert position and a retracted position. The light reducing filter crosses the luminous flux emerging from the first emergent surface between the first emergent surface and the second incident surface in the insert position. The light reducing filter is deviated from the luminous flux in the retracted position.

In addition, in order to improve assembling precision of an optical system, the first prism and the second prism are provided with an engagement portion for keeping mutual relative positions. In this case, more preferably, an engagement portion provided in the first prism side and an engagement portion provided at the second prism side are directly engaged with each other.

In addition, it is also preferable that the image sensing device comprises a frame which holds the first prism, the second prism, the shutter mechanism and the image sensing element in a specific positional relation. In this case, the frame has a first wall which positions and holds the shutter mechanism between the first prism and the second prism and a second wall which positions and holds the image sensing element on an image focusing surface. In addition, the first wall and the second wall are integrally formed.

The image sensing apparatus according to the present invention has processing means to obtain image data by executing predetermined electrical processing to an electrical signal obtained by the image sensing device described above and recording means to record image data from the processing means in an applied information recording medium.

The image sensing device according to the present invention can interrupt the light incident to the image sensing element while reading out image data from the image sensing element. Therefore, the exposure times of the odd numbered field and the even numbered field of the interlace type CCD can be identical to each other. In addition, by using this image sensing device, there can be provided an image sensing apparatus capable of acquiring a good quality image while compactly maintaining the size of the entire apparatus.

In addition, according to an invention in which a light reducing filter of open and close type is provided in a shutter mechanism, an amount of light can be regulated. Thus, in a state such as a object condition with large difference in brightness and darkness, in which an electronic shutter function having an image sensing element is insufficient, by properly inserting the light reducing filter, a good quality image can be obtained even by an electronic shutter which the image sensing element has.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a digital camera having an image sensing device according to a first embodiment of the present invention;

FIG. 2 is a sectional view schematically showing an inside of the digital camera shown in FIG. 1;

FIG. 3 is an exploded view of an image sensing device of the digital camera shown in FIG. 1;

FIG. 4 is a partially sectional side view of the image sensing device shown in FIG. 3;

FIG. 5 is an enlarged view showing an engagement portion of a first prism and an engagement portion of a second prism shown in FIG. 4;

FIG. 6 is an exploded view showing a shutter mechanism and a filter mechanism of the image sensing device shown in FIG. 3;

FIG. 7 is a sectional view selectively passing an engagement portion of the shutter mechanism and filter mechanism of the image sensing device shown in FIG. 3;

FIG. 8 is a front view showing a shutter mechanism in an open state taken along the line A-A in FIG. 6;

FIG. 9 is a front view showing a shutter mechanism in a closed state taken along the line A-A in FIG. 6;

FIG. 10 is a front view showing a filter mechanism in a non-light reducing state taken along the line B-B in FIG. 6;

FIG. 11 is a front view showing a filter mechanism in a light reducing state taken along the line B-B in FIG. 6;

FIG. 12A is a sectional view showing another embodiment of the engaging portion shown in FIG. 5;

FIG. 12B is a sectional view showing another embodiment of the engaging portion shown in FIG. 5;

FIG. 12C is a sectional view showing another embodiment of the engaging portion shown in FIG. 5;

FIG. 12D is a sectional view showing another embodiment of the engaging portion shown in FIG. 5;

FIG. 13 is a sectional view showing a joint portion of a frame in another embodiment in which a first wall and a second wall are provided at another member;

FIG. 14 is a front view showing another embodiment in which an aperture plate is provided instead of an ND filter;

FIG. 15 is a disassembled perspective view showing an image sensing device according to a second embodiment of the present invention;

FIG. 16 is a partially sectional side view showing the image sensing device shown in FIG. 15;

FIG. 17 is a sectional view showing a joint portion of a frame in another embodiment in which the first wall and the second wall of the frame of FIG. 15 are provided independently;

FIG. 18 is a perspective view showing a cellular phone with a camera as another example of an image sensing apparatus according to the present invention;

FIG. 19 is a sectional view schematically showing another example of a prism optical system; and

FIG. 20 is a sectional view schematically showing still another example of the prism optical system.

### DETAILED DESCRIPTION OF THE INVENTION

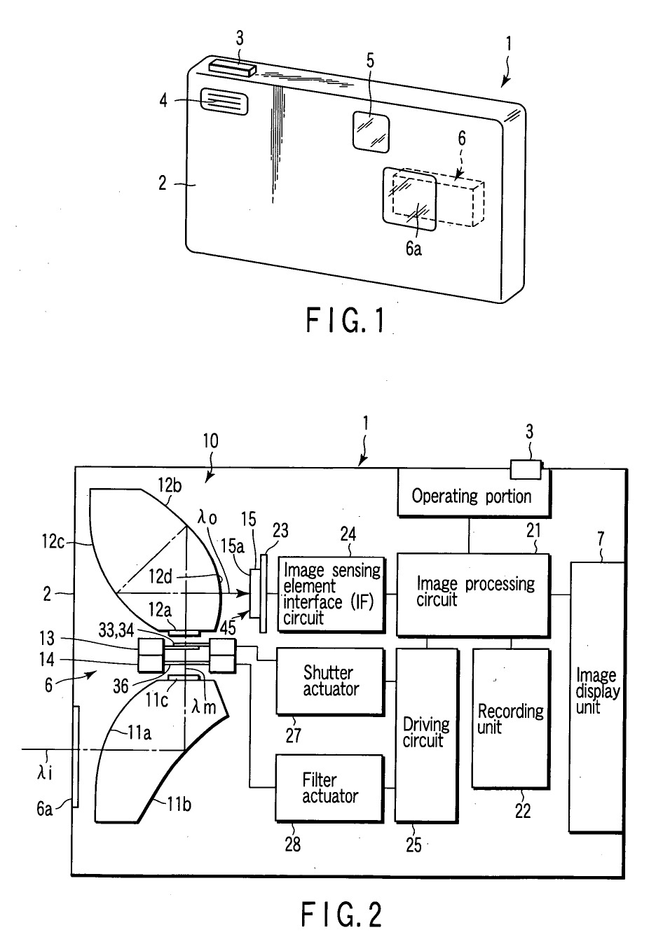

An image sensing device according to a first embodiment of the present invention will be described by way of one example of a digital camera 1 with reference to FIG. 1 to FIG. 4. As shown in FIG. 1, the digital camera 1 has a release button 3, a flash 4, a finder optical system 5, an image sensing optical system 6, and an image display unit 7 (refer to FIG. 2), which are arranged on the outer surface of a housing 2. The release button 3 is one of operating portions.

As shown in FIG. 2, the housing 2 incorporates devices: such as, an image sensing device 10 which configures main parts of an image sensing optical system 6; an image processing circuit 21 serving as processing means; and a recording unit 22 serving as recording means. The image processing circuit 21 has a function of executing predetermined electrical processing to an electrical signal obtained by the image sensing device 10, thereby obtaining image data. The recording unit 22 functions as recording means for temporarily storing the image data from the image processing circuit 21 and recording the image data in an applied recording medium. An incident window 6a through which a luminous flux from an object made incident to the image sensing device 10 passes is provided in the housing 2.

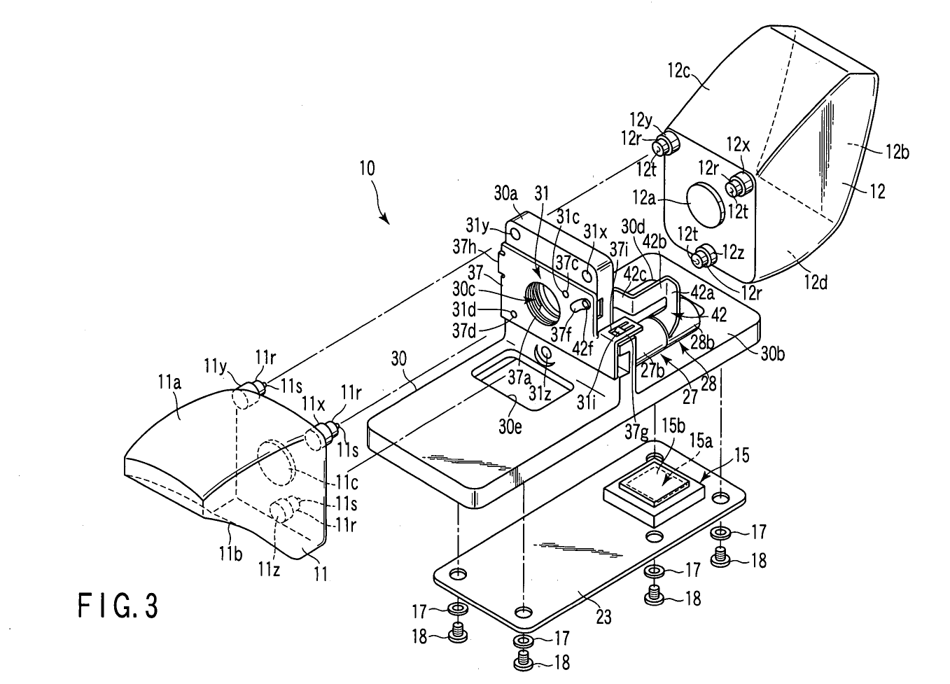

As shown in FIG. 2 and FIG. 3, the image sensing device 10 has a first prism 11, a second prism 12, a shutter mechanism 13, a filter mechanism 14, and an image sensing element 15. The first prism 11 is an eccentric prism including a first incident surface 11a, a first reflecting surface 11b, and a first emergent surface 11c. The first reflecting surface 11b is formed in the shape of a rotationally asymmetric free-form surface. The second prism 12 is an eccentric prism including a second incident surface 12a, two second reflecting surface 12b, 12c, and a second emergent surface 12d. The two second reflecting surfaces 12b, 12c are formed in the shape of a rotationally asymmetric free-form surface, respectively.

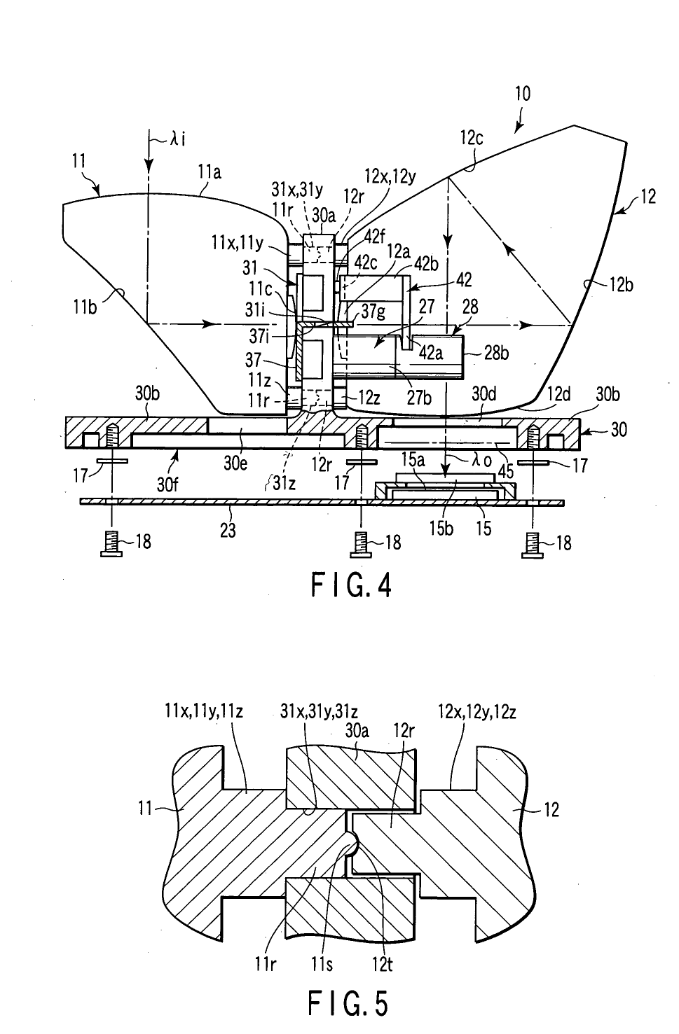

As shown in FIG. 4, a luminous flux λi reflected from an object is incident from the first incident face 11a, and emerges from the first emergent surface 11c, after having been reflected on the first reflecting surface 11b. A luminous flux λm emerged from the first emergent surface 11c of the first prism 11 is incident from the second incident surface 12a, and emerged from the second emergent surface 12d after being reflected on the two second reflecting surfaces 12b, 12c respectively. Then a luminous flux λo emerged from the second emergent surface 12d forms an object image on an image focusing surface 45.

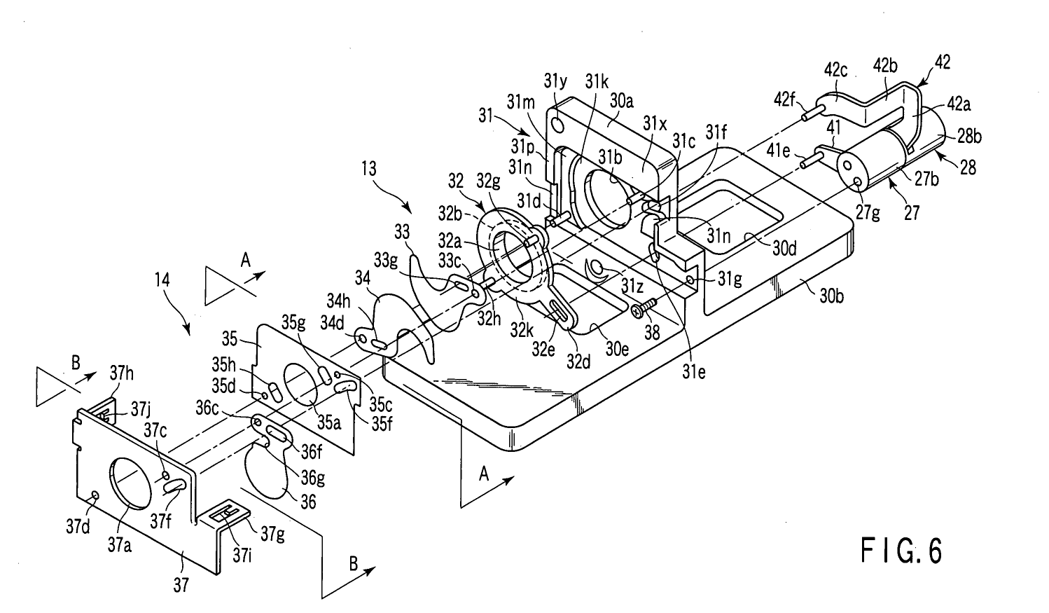

As shown in FIG. 4, the shutter mechanism 13 and the filter mechanism 14 are arranged between the first emergent surface 11c of the first prism 11 and the second incident surface 12a of the second prism 12. As shown in FIG. 6, the shutter mechanism 13 has: two shutter blades 33, 34; and a blade drive ring 32 which is a part of a blade drive mechanism. The filter mechanism 14 has an ND (Natural Density) filter 36 serving as a light reducing filter. A shutter actuator 27 is linked with the shutter blades 33, 34 via a blade drive ring 32. A filter actuator 28 is linked with the ND filter 36. A detailed description of these elements will be given later.

The image sensing element 15 is mounted on a substrate 23. A light-receiving surface 15a of the image sensing element 15 is arranged on an image focusing surface 45. The image sensing element 15 is a CCD (Charge-coupled device) in which semiconductor elements for converting light into an electrical signal are arranged in plurality on the light-reserving surface 15a. As shown in FIG. 4, the filter 15b is mounted between the second emergent surface 12d and the light-receiving surface 15a. A cover glass is mounted instead of the filter 15b. On the substrate 23, an image element IF (interface) circuit 24 communicating between the image sensing element 15 and the image processing circuit 21 is mounted. In addition, a driving circuit 25 for actuating a shutter actuator 27 and a filter actuator 28 may be mounted on the substrate 23.

The first prism 11, the second prism 12, the shutter mechanism 13, and the image sensing element 15 are mounted on a frame 30. The frame 30 has a first wall 30a and a second wall 30b. As shown in FIG. 4, the first wall 30a is sandwiched between the first prism 11 and the second prism 12, and is arranged in a direction crossing the luminous flux λm emerging from the first emergent surface 11c. The second wall 30b is arranged in a direction crossing the luminous flux λo emerging from the second emergent surface 12d, and extends to the first prism 11 side. The frame 30 is formed continuously in a T shape such that the first wall 30a abuts against the second wall 30b. The opening portions 30c, 30d through which the luminous fluxes λm, λo pass are provided on the first wall 30a and the second wall 30b, respectively.

In addition, mount holes 31x, 31y, 31z communicating with the first prism 11 side and the second prism 12 side are provided at three portions surrounding an opening portion 30c of the first wall 30a. In the present embodiment, two mount holes 31x, 31y are provided at corner portions spaced from the second wall 30b with respect to the opening portion 30c, and one mount hole 31z is provided at a position close to the second wall 30b with respect to the opening portion 30c.

In the first prism 11 and the second prism 12, columnar engagement portions 11x, 11y, 11x, 12x, 12y, 12z are formed at positions corresponding to the mount holes 31x, 31y, 31z. At the engagement portions 11x, 11y, 11z, 12x, 12y, 12z, there are provided press-fit portions 11r, 12r which is formed by one turn more thinly than the engagement portions 11x, 11y, 11z, 12x, 12y, 12z, and inserts to the mount holes 31x, 31y, 31z. In the present embodiment, as shown in FIG. 5, the press-fit holes 11r of the first prism 11 is engagingly fitted to the mount holes 31x, 31y, 31z, and the press-fit portion 12r of the second prism 12 is slightly spaced from the mount holes 31x, 31y, 31z. Therefore, at least the second prism 12 is fixedly bonded to the first wall 30a.

A positioning protecting portion 11s is provide at a tip end of the press-fit portion 11r of the first prism 11. A positioning projecting portion 12t is provided at a tip end of the press-fit portion 12r of the second prism 12 opposed to the press-fit portion 11r. The first prism 11 and the second prism 12 are directly abutted by the projecting portion 11s and the recessed portion 12t, and are relatively positioned. In addition, the press-fit portion 11r of the first prism 11 is engagingly fitted to mount holes 31x, 31y, 31z, whereby the frame 30, the first prism 11, and the second prism 12 are relatively positioned.

These shapes are intended to ensure relative positioning between the first prism 11 and the second prism 12, and may be formed in a reversed manner. Further, the function is identical even if a combination of the press-fit portion 11r, 12r and the projection portion 11s and the recessed portion 12t is changed. Therefore, for example, the press-fit portion 12r of the second prism 12 is engagingly fitted to the mount holes 31x, 31y, 31z, and the recessed portion 12t may be provided at its tip end. In addition, as shown in FIG. 3, a viewing window 30e for verifying that the press-fit portion 11r of the first prism 11 is correctly engagingly fitted to the mount hole 31z provided close to the second wall 30b is provided on the second wall 30b which extends to the first prism 11 side.

As shown in FIG. 6, a shutter/filter holding portion 31 is provided on the first wall 30a of the first prism 11 side. The shutter mechanism 13 including the shutter blades 33, 34 and the filter mechanism 14 including the ND filter 36 are incorporated in the shutter/filter holding portion 31. As shown in FIG. 4, a substrate mount portion 30f is provided on the second wall 30b at the opposite side of the second prism 12. The substrate 23 is fixed to the substrate mount portion 30f by a lock screw 18 by properly sandwiching a spacer 17 so that the light-receiving surface 15a of the image sensing element 15 is positioned on the image focusing surface 45. As shown in FIG. 3, the lock screw 18 is set so that an angle of the image sensing element 15 can be adjusted in a direction taken along a surface on which optical axes of the luminous fluxes λi, λm, λo looped by the first prism 11 and the second prism 12 pass and in a direction perpendicular thereto.

As has been described above, the first prism 11, the second prism 12, the shutter mechanism 13, the filter mechanism 14, and the image sensing element 15 are fixed to the frame 30, whereby a mutual relative position is held with respect to the first prism 11, the second prism 12, the shutter mechanism 13, the filter mechanism 14, and the image sensing element 15, respectively.

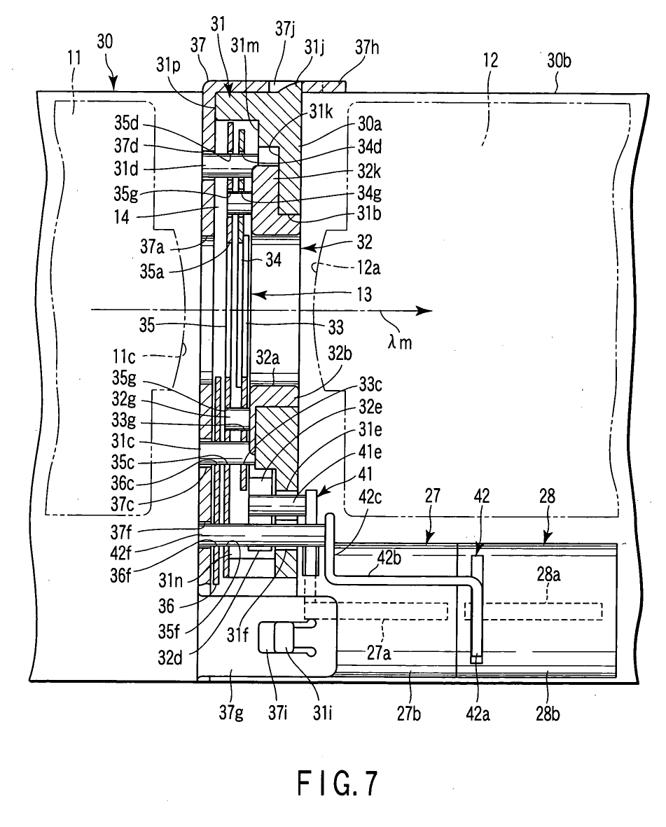

Next, a detailed configuration of the shutter mechanism 13 and filter mechanism 14 incorporated in the shutter/filter holding portion 31 provided on the first wall 30a of the frame 30 will be described with reference to FIG. 6 and FIG. 7.

In the shutter/filter holding portion 31, as shown in FIG. 6, a blade drive ring 32 of a shutter mechanism 13; two shutter blades 33, 34; a spacer 35 for spacing the shutter mechanism 13 and the filter mechanism 14 from each other; an ND filter 36 of the filter mechanism 14; and a cover 37 for covering the shutter/filter holding section 31 are mounted to be superimposed in order to the first wall 30a.

In addition, an image sensing device 10 has a shutter actuator 27 and a filter actuator 28 at the second prism 12 side of the first wall 30a. The shutter actuator 27 is a part of the blade drive mechanism linked with the shutter blades 33, 34 via the blade drive ring 32. The filter actuator 28 is a filter drive mechanism linked with the ND filter 36. The shutter actuator 27 and the filter actuator 28 are actuators of rotary solenoid type, each of which incorporates rotary shafts 27a, 28a and a coil in main body cases 27b 28b.

In the present embodiment, a rotary shaft 27a of the shutter actuator 27 and a rotary shaft 28a of the filter actuator 28 are arranged coaxially in parallel to a direction taken along an optical axis of the luminous flux λm emerging from the fist emergent surface 11c along a direction in which the first prism 11 and the second prism 12 are arranged. A main body case 27b of the shutter actuator 27 and a main body case 28b of the filter actuator 28 are integrally formed, and a screw hole 27q is provided on an end face of the shutter actuator 27 side arranged close to the first wall 30a. A screw through hole 31q is provided on the first wall 30a. The shutter actuator 27 and the filter actuator 28 are fixed to the first wall 30a by a screw 38 spirally fitted to the screw hole 27q through the screw through hole 31q. That is, the shutter actuator 27 is arranged closer to the positions of the shutter blades 33, 34 and the ND filter 36.

A blade drive arm 41 extending in a radial direction is fixedly attached to the rotary shaft 27a of the shutter actuator 27. At a tip end of the blade drive arm 41, the ring drive pin 41e extending to the first prism 11 side is mounted along an optical axis direction of the luminous flux οm. The ring drive pin 41e is passed through an arc shaped elongated hole 31 provided on the first wall 30a along the rotational direction of the blade drive arm 41.

A filter drive arm 42 is fixedly attached to a rotary shaft 28a of the filter actuator 28. The filter drive arm 42 has a proximal portion 42a, an extension portion 42b, and a tip end portion 42c. The proximal portion 42a extends in a radial direction from the rotary shaft 28a. The extension portion 42b extends from the rotary end of the proximal portion 42a toward the first wall 30a parallel to the optical axis of the luminous flux λm. A tip end portion 42c is bent along the first wall 30a at a side end of the first wall 30a of the extension portion 42b. A filter drive pin 42f extending along the first prism 1 side along the optical axis direction of the luminous flux λm is mounted on the tip end portion 42c. The filter drive pin 42f is passed through the arc shaped elongated hole 31f and an arc shaped filter drive pin through hole 35f. The elongated hole 31f is provided on the first wall 30a along the rotational direction of the filter drive arm 42. The filter drive pin through hole 35f is provided in the spacer 35 along the rotational direction of the filter drive arm 42.

The filter drive arm 42 is looped in complex as described above because this arm bypasses the second prism 12 so as to avoid interference with the second prism 12. Therefore, the rotary shaft 27a of the shutter actuator 27 and the rotary shaft 28 of the filter actuator 28 are arranged in parallel, and are arranged on the first wall 30a serving as a position which does not interference with the second prism 12, whereby the shape of the filter drive arm 42 can be simplified.

As shown in FIG. 6, an engagement opening 31b, support pins 31c, 31d, elongated holes 31e, 31f, a first plane portion 31k, a second plane portion 31m, a third plane portion 31n, a fourth plane portion 31p, and a screw through hole 31q are provided in the shutter/filter holding portion 31. The engagement opening 31b penetrates the first wall 30a around the optical axis of the luminous flux λm.

The first plane portion 31k spreads in a direction crossing the optical axis of the luminous flux λm on the first prism 11 side of the engagement opening 31b. At the first plane portion 31k, there are provided: an elongated hole 31e through which the ring drive pin 41e is passed; an elongated hole 31f through which the filter drive pin 42f is passed; and a through hole 31q through which a screw 38 for fixing the shutter actuator 27 and the filter actuator 28 to the first wall 30a is passed. The elongated hole 31e is provided in an arc shaped along a trajectory in which the ring drive pin 41e moves. The elongated hole 31f is provided an arc shape along a trajectory in which the filter drive pin 42f moves.

The first plane portion 31k, the second plane portion 31m, the third plane portion 31n, and the fourth plane portion 31p are arranged in parallel to each other. The second plane portion 31m is provided at the first prism 11 side rather than the first plane portion 31k. The third plane portion 31n is provided at the first prism 11 side rather than the second plane portion 31m. The fourth plane portion 31p is provided at the first prism 11 side rather than the third plane portion 31n. Support pins 31c, 31d are arranged at a position which is symmetrical to the second plane portion 31m around the optical axis of the luminous flux λm.

In the present embodiment, the fourth plane portion 31p is a side face of the first prism 11 of the first wall 30a. That is, the mount holes 31x, 31y, 31z into which an engagement portion of the first prism 11 and the second prism 12 is inserted are provided to penetrate from the fourth plane portion 31p to a face at the second prism 12 side.

A blade drive ring 32 has a ring opening 32a, an engagement projecting portion 32b, a flange portion 32k, an arm portion 32d, an elongated hole 32e, and blade drive pins 32g, 32h. The ring opening 32a is provided in a circular shape around the optical axis of the luminous flux λm. The engagement projecting portion 32b is formed in a cylindrical shape whose external diameter is slightly smaller than an internal diameter of the engagement opening 31b, and is engagingly inserted into the engagement opening 31b. The flange portion 32k spreads in a jaws shape from the first prism 11 side of the engagement projecting portion 32b along the first plane portion 31k, and slidably comes into contact with the first plane portion 31k.

The arm portion 32d extends in a radiation direction from the flange portion 32k toward a position which communicates with the elongated hole 31f provided at the first plane portion. The elongated hole 32e is provided at the arm portion 32d, and an elongated diameter is arranged in a radial direction around the optical axis of the luminous flux λm. The elongated hole 32e penetrates the first wall 30a, and is engaged with the ring drive pin 41e projected to the first prism 11 side. Therefore, when the blade drive arm 41 is rotated by the shutter actuator 27, the blade drive ring 32 rotates around the optical axis of the luminous flux λm. The blade drive pins 32g, 32h are arranged at the flange portion 32k rotationally symmetrically around the optical axis of the luminous flux λm, and extends toward the first prism 11 side.

Shutter blades 33, 34 are formed in a new moon shape or in a sickle shape, and at one end, pin holes 33c, 33d and sliding elongated holes 33g, 33h are provided, respectively. The shutter blade 33 is mounted on a shutter/filter holding portion 31 in a state in which the support pin 31c is inserted into the pin hole 33c. The shutter blade 34 is mounted on the shutter/filter holding portion 31 in a state in which the support pin 31d is inserted into the pin hole 34d.

The shutter blades 33, 34 are arranged rotationally symmetrically around the optical axis of the luminous flux λm in a state in which a part of these shutters is superimposed in a direction along the optical axis of the luminous flux λm with the inside of an arc toward the optical axis side of the luminous flux λm. The sliding elongated holes 33g, 34h are engaged with the blade drive pins 32g, 32h, respectively. In this manner, when the blade drive ring 32 is rotated by the shutter actuator 27, the shutter blades 33, 34 rotate around the support pins 31c, 31d, respectively.

A spacer 35 is mounted on the shutter/filter holding portion 31 at the more inside of the fourth plane portion 31p. The spacer 35 includes: an aperture opening 35a; support pin through holes 35c, 35d; a filter drive pin through hole 35f; and blade drive pin through holes 35g, 35h. The aperture opening 35a is a circular hole around the optical axis of the luminous flux λm. An opening diameter of the aperture opening 35a is slightly smaller than the ring opening 32.

The spacer 35 is mounted on the shutter/filter holding portion 31 in a state in which the spacer abuts against the third plane portion 31n while the support pins 31c, 31d are passed through the support pin through holes 35c, 35d.

The support pin through holes 35c, 35d are provided as release holes of the blade drive pins 32g, 32h. These support pin through holes are formed in an arc shaped elongated hole which corresponds to a trajectory in which the blade drive ring 32 rotates, whereby the blade drive pins 32g, 32h move. The filter drive pin through hole 35f is formed in an arc shaped elongated hole which corresponds to a trajectory in which the filter actuator 28 rotates the filter drive arm 42, whereby the filter drive pin 42f moves.

The spacer 35 ensures a rotational gap in a direction along the optical axis of the luminous flux λm of the shutter blades 33, 34. In addition, this spacer separates the shutter blades 33, 34 and the ND filter 36 from each other so as to rotate independently.

As shown in FIG. 11, the ND filter 36 has a sufficient size which covers the aperture opening 35a. This ND filter has a support pin through hole 35c, a filter drive pin through hole 36f, and a cutout portion 36g. The ND filter 36 is mounted in a state in which the support pin through hole 35c and the filter drive pin through hole 36f are mounted with the support pin 31c and the filter drive pin 42f which project from the spacer 35 to the first prism 11 side, respectively.

As shown in FIG. 11, a cutout portion 36g is provided in a shape such that the cutout portion 36 is not superimposed on the blade drive pin through hole 35g in a direction taken along the optical axis of the luminous flux λm so that the ND filter 36 and the blade drive pin 32g do not interface with each other. When the blade drive pins 32g, 32h do not project to the first prism 11 side beyond the spacer 35, the cutout portion 36g is not required.

The ND filter 36 rotates along the support pin 31c by the filter actuator 28 rotating the filter drive arm 42. In addition, the ND filter 36 is selectively positioned and held in either one of an insert position (FIG. 10) crossing the luminance flux λm emerging from the first emergent surface 11c and a retracted position (FIG. 11) coming out of the luminous flux λm.

A cover 37 abuts against a fourth plane portion 31p, and includes an opening portion 37a, support pin engagement holes 37c, 37d, a filter drive pin through hole 37f, and an locking pieces 37g, 37h. The opening portion 37a is provided in a circular shape around the optical axis of the luminous flux λm. The support pin engagement holes 37c, 37d are engaged with a tip end of the support pins 31c, 31d. Thus, the support pins 31c, 31d function as a rotary center shaft of the shutter blades 33, 34, and functions as a fixing member of the spacer 35 and cover 37.

The filter drive pin through hole 37f is formed in an arc shaped elongated hole which corresponds to trajectory in which the filter drive pin 42f is moved by the filter actuator 28 rotating the filter drive arm 42. The locking pieces 37g, 37h are looped back to the first prism 11 side so as to overlap on the outer periphery of the first wall 30a. The locking pieces 37a, 37h have locking holes 37i, 37j. The locking holes 37i, 37j are locked with locking projections 31i, 31j formed at the outer periphery of the first wall 30a.

The shutter mechanism 13 and filter mechanism 14 assembled as described above are incorporated in the shutter/filter holding portion 31 of the first wall 30a via the spacer 35. The shutter mechanism 13 holds the shutter blades 33, 34, and the filter mechanism 14 holds the ND filter 36 in a state in which they can be rotated respectively independently.

The shutter mechanism 13 and the filter mechanism 14 are arranged to be housed in a projection area of the first wall 30a in a direction taken along the optical axis of the luminous flux λm. In this manner, an occupying area of the image sensing device 10 on a perpendicular surface with respect to the optical axis of the luminous flux λm is determined depending on the size of the frame 30.

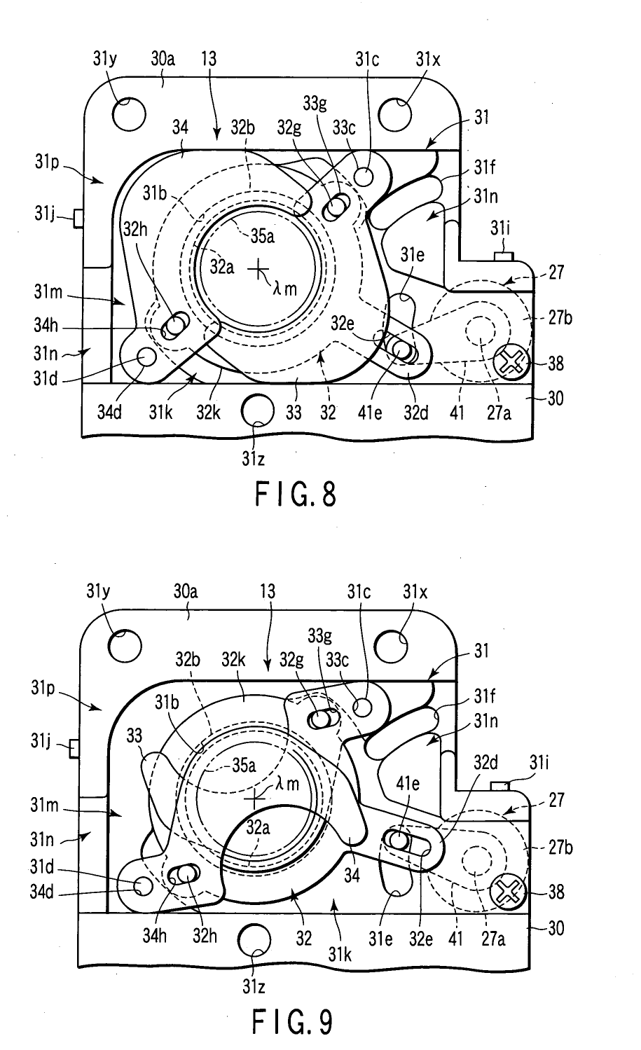

An operation of the shutter blades 33, 34 of the above described shutter mechanism 13 will be described with reference to FIG. 8 and FIG. 9. FIG. 8 and FIG. 9 are plan views when the shutter mechanism 13 is seen from the first prism 11 side along the line A-A in FIG. 6. An open state of the shutter mechanism 13 is shown in FIG. 8, and a closed state of the shutter mechanism 13 is shown in FIG. 9.

A shutter actuator 27 is turned OFF in an open state. A rotary shaft 27a is biased in the counterclockwise direction in FIG. 8 by a coil spring or the like, for example, incorporated in a main body case 27b. Therefore, the blade drive ring 32 engaged with the ring drive pin 41e of a blade drive arm 41 is biased in the clockwise direction in FIG. 8. As a result, the shutter blades 33, 34 are held at a release position hidden in a projection area of a spacer 35, as shown in FIG. 8, in an open state, and the luminous flux λm emerging from the first emergent surface 11c is passed to the second incident surface 12a. Then, the shutter blades 33, 34 abut against an internal wall of the shutter/filter holding portion 31, the ring drive pin 41e abuts against the elongated hole 31e, or the arm portion 32d of the blade drive ring 32 abuts against the internal wall of the shutter/filter holding section 31, whereby the open state shown in FIG. 8 is maintained. The shutter mechanism 13 enters the open state shown in FIG. 8 in a normal state.

The shutter actuator 27 passing the light radiated from an object image during a predetermined time after an image sensing operation is made is turned ON, and the blade drive arm 41 is rotated in the clockwise direction together with the rotary shaft 27a. In this manner, the blade drive ring 32 engaged with the blade drive arm 41 by the ring drive pin 41e is rotated in the counterclockwise direction around the optical axis of the luminous flux λm. Then, the shutter blades 33, 34 engaged with the blade drive pins 32g, 32h are rotated around the support pins 31c, 31d at an interruption position crossing the luminous flux λm as shown in FIG. 9.

As a result, the shutter mechanism 13 enters a closed state for interrupting the luminous flux λm emerging from the first emergent surface 11c which covers the ring opening 32a. Therefore, continuous impinging of the luminous flux from an object to the image sensing element 15 can be prevented in duration while image data has been picked up from the image sensing element 15. Therefore, exposure times of the odd numbered field and the even numbered field of the interlace type CCD can be made identical to each other.

In addition, an operation of the ND filter 36 of the above described filter mechanism 14 will be described with reference to FIG. 10 and FIG. 11. FIG. 10 and FIG. 11 are plan views when the filter mechanism 14 is seen from the first prism 1 side along the line B-B in FIG. 6. FIG. 10 shows a non-light reducing state in which the ND filter 36 is held in a retracted state. FIG. 11 shows a state in which the ND filter 36 is held at an insert position.

The filter actuator 28 turns OFF in the non-light reducing state. The rotary shaft 28a is biased in the clockwise direction in FIG. 10 by a torsion coil spring or the like, for example, incorporated in the main body case 28b. Therefore, the ND filter 36 engaged through the filter drive pin through hole 36f with respect to the filter drive pin 42f of the filter drive arm 42 is biased in a direction rotating in the counterclockwise direction in FIG. 10 around the support pin 31c.

As a result, the ND filter 36, in the non-light reducing state, is held at a retracted position coming out of an aperture opening 35a which is a position hidden in the projection area of the spacer 35, as shown in FIG. 10. Then, the luminous flux λm emerging from the first emergent surface 11c of the first prism 11 passes through the aperture opening 35a without passing through the ND filter 36, and is made incident to the second incident surface 12a of the second prism 12. As shown in FIG. 10, the ND filter 36 abuts against any one of the elongated hole 31f at which the filter drive pin 42f is provided on the first wall 30a; the filter drive pin through hole 35f of the spacer 35; and the filter drive pin through hole 37f of the cover 37, whereby the ND filter is maintained at a retracted position. The filter mechanism 14 enters the non-light reducing state shown in FIG. 10 in a normal state.

Based on a luminescence gauge provided independently in the digital camera 1 which is an image sensing apparatus, or based on luminescence detected by the image sensing element 15, if the light from an object is too strong, the filter actuator 28 is turned ON. In this manner, the filter drive arm 42 is rotated in the counterclockwise direction together with the rotary shaft 28a. The ND filter 36 engaged with the filter drive arm 42 by the filter drive pin 42f is rotated in the clockwise direction from the retracted position around the support pin 31c, and is held at an insert position crossing the luminous flux λm, as shown in FIG. 11.

As a result, the luminous flux λm emerging from the first emergent surface 11c passes through the ND filter 36, whereby light is reduced at a ratio which this NF filter 36 has, and then the reduced light is incident to the second incident surface 12a of the second prism 12. Therefore, even when the luminescence of an object covers a wide region, an image can be sensed with fine gradation.

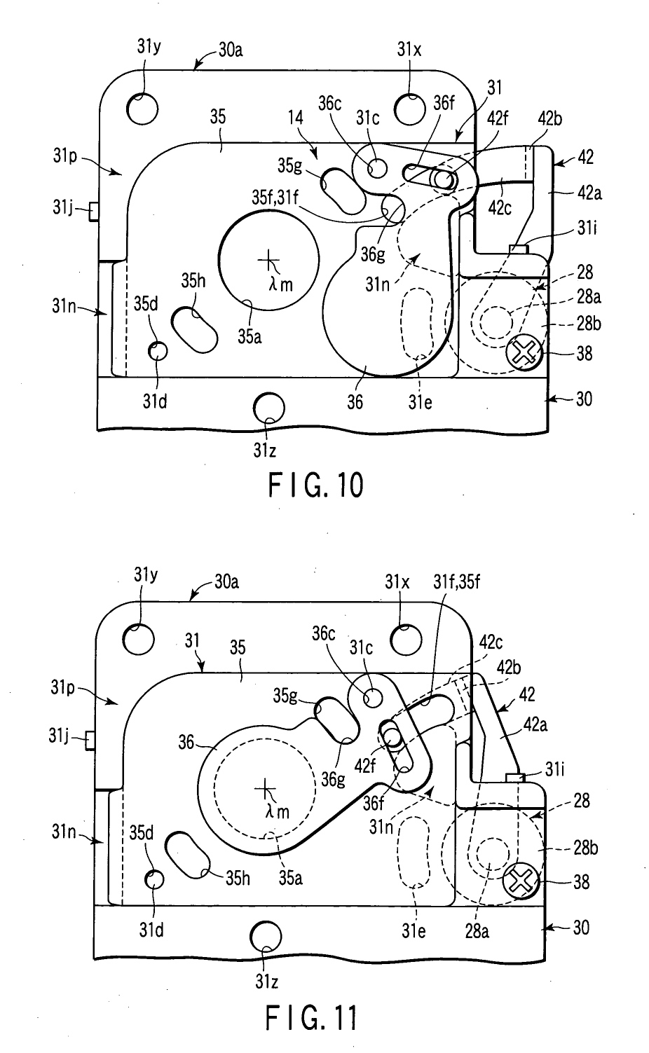

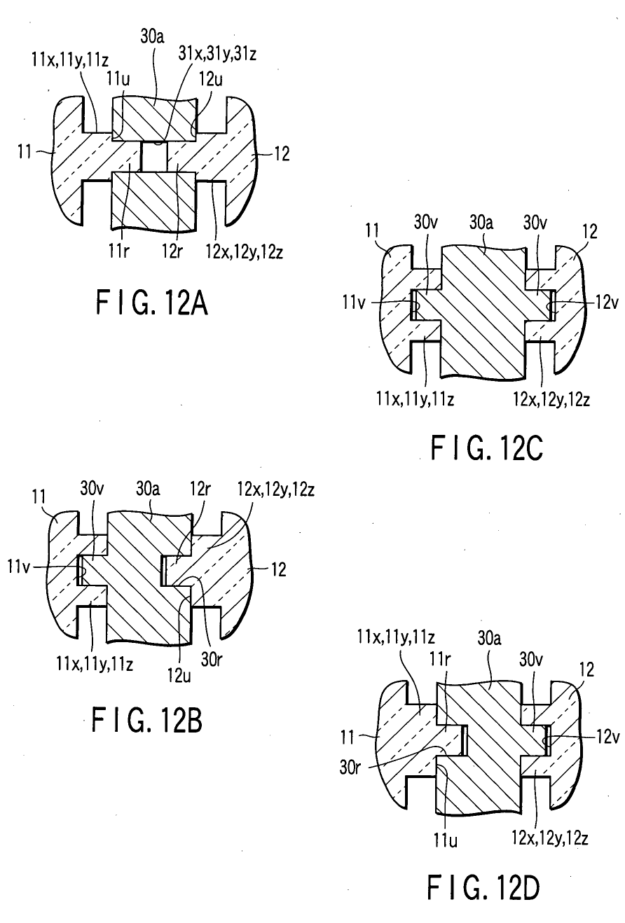

FIG. 12A, FIG. 12B, FIG. 12C, and FIG. 12D show another embodiment a mount configuration between an engagement portion of the first prism 11 and the second prism 12 and mount holes 31x, 31y, 31z provided on the first wall 30a, respectively. As shown in the figures, the first prism 11 and the second prism 12 may not be shaped so as not to be directly in contact with each other. In any embodiment of FIG. 12A, FIG. 12B, FIG. 12C, and FIG. 12D, the first prism 11 and the second prism 12 can be relatively positioned via the first wall 30a.

In the embodiment shown in FIG. 12A, the engagement portions 11x, 11y, 11z, 12x, 12y, 12z provided in the first prism 1 and the second prism 12 include press-fit portions 11r, 12r to be engagingly fitted to the mount holes 31x, 31y, 31z provided on the first wall 30a respectively. The proximal portions 11u, 12u of the respective press-fit portions 11r, 12r abut against an external surface of the first wall 30a, whereby the first prism 11 and the second prism 12 are relatively positioned via the first wall 30a.

In the embodiment shown in FIG. 12B, the engagement portions 11x, 11y, 11z, 12x, 12y, 12z provided in the first prism 11 and the second prism 12 includes recessed portions 11v, 12v externally engaged with a mount boss 30v provided on the first wall 30a, respectively. Tip ends of the engagement portions 11x, 11y, 11z, 12x, 12y, 12z abut against the external surface of the first wall 30a, whereby the first prism 11 and the second prism 12 are relatively positioned via the first wall 30a, respectively.

In the embodiment shown in FIG. 12C, the engagement portions 11x, 11y, 11z provided in the first prism 11 is formed in a shape similar to the engagement portions 11x, 11y, 11z of the first prism 11 shown in FIG. 12B. The engagement portions 12x, 12y, 12z provided in the first prism 12 is formed in a shape similar to the engagement portions 12x, 12y, 12z of the second prism 12 shown in FIG. 12A. The press-fit portion 12r of the engagement portions 12x, 12y, 12z is engagingly inserted into the engagement hole 30r provided on the first wall 30a.

In the embodiment shown in FIG. 12D, the engagement portions 11x, 11y, 11z provided in the first prism 11 is formed in a shape similar to the engagement portions 11x, 11y, 11z of the first prism 11 shown in FIG. 12A. The engagement portions 12x, 12y, 12z provided in the first prism 12 is formed in a shape similar to the engagement portions 12x, 12y, 12z of the first prism 12 shown in FIG. 12B. The press-fit portion 11r of the engagement portions 11x, 11y, 11z is engagingly inserted into the engagement hole 30r provided on the first wall 30a.

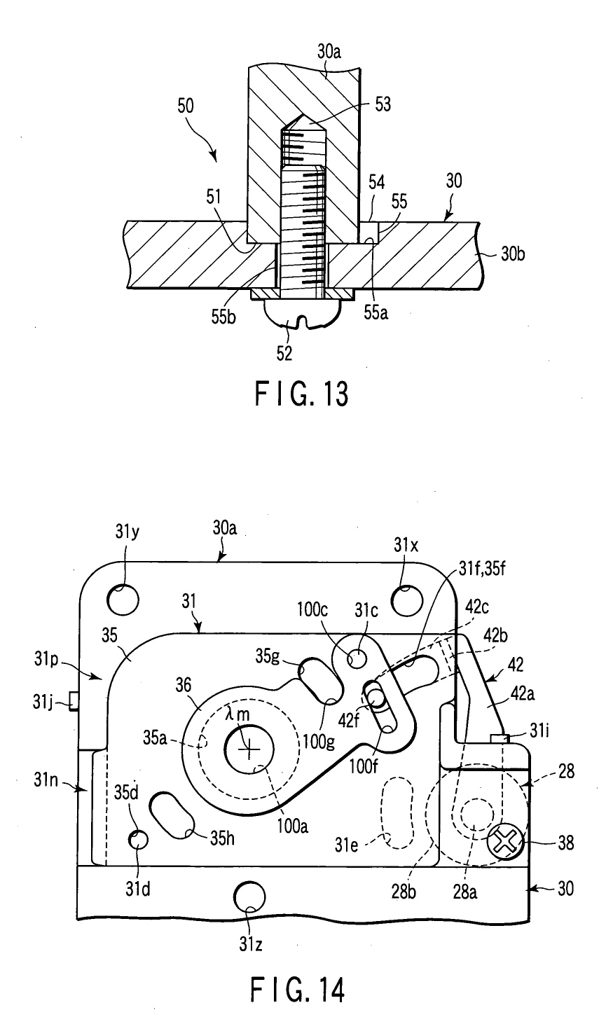

In addition, with respect to the frame according to an embodiment in which the first wall 30a and the second wall 30b are composed of another member, respectively, a configuration of these joint portion 50 is shown in FIG. 13 in an enlarged manner. As shown in FIG. 13, a joint end 51 of the first wall 30a has a screw hole 53 spirally fitted with a fixing screw 52. A groove 55 is formed on a joint face 54 of the second wall 30b. The width of the groove 55 is formed to be wider than that of the joint end 51. A screw through hole 55b through which the fixing screw 52 is inserted is provided at a bottom part 55a. The screw through hole 55b is provided in a position superimposed on the screw hole 53 in a state in which the joint end 51 is pressed against one side wall of the groove 55. As shown in FIG. 13, the first wall 30a and the second wall 30b are positioned each other by two surfaces.

FIG. 14 shows a state in which an aperture plate 100 is mounted instead of the ND filter 36. The aperture plate 100 has an aperture hole 100a whose opening diameter is smaller than the aperture opening 35a provided in the spacer 35 to the coaxial optical axis of the luminous flux λm. The aperture plate 100 is pivoted on a support pin 31c by a support pin through hole 100c provided in the same manner as in the ND filter 36. In addition, this aperture plate is rotated by the filter drive pin 42f engaged with a drive pin through hole 10f, and is positioned at either of the insert position and the retracted position. In addition, as in the ND filter 36, a cutout portion 100g which avoids interference with the blade drive pin 32g is provided.

This aperture plate 100 is driven in the same manner as the ND filter 36, whereby an amount of light transmitted to the image sensing element 15 can be changed. The opening diameter of the aperture hole 100a is properly determined according to use of an image sensing device, and is not limited to a ratio based on a relationship between the aperture opening 35a and the aperture hole 100a.

In addition, in the ND filter 36 in the present embodiment, the shutter mechanism 13 and the filter mechanism 14 can be functionally switched from each other by changing the filter to a light interrupting member. For example, a light interrupting member provided instead of the ND filter 36 is used as a mechanical shutter for switching an open state into a closed state and vice versa. In addition, a restriction is applied to a rotational range of the blade drive arm 41, a restriction is applied to a rotational range of the blade drive ring 32, or a restriction is applied to a rotational range of the shutter blades 33, 34, thereby holding the shutter blades 33, 34 in an aperture state in which an opening smaller than the aperture opening 35a of the spacer 35 is left.

In addition, if the shutter blades 33, 34 are driven and positioned at the shutter actuator 27 at a plurality of stages by using a stepping motor, there can be provided an aperture mechanism capable of setting a plurality of aperture values. With respect to the number of shutter blades, a more circular opening can be produced by increasing the number. In addition, the shutter actuator 27 and the filter actuator 28 can be replaced with a hollow motor provided coaxially to the optical axis of the luminous flux λm.

In an image sensing condition such that an opening of an aperture formed of the shutter blades 33, 34 or an opening of the aperture hole 100a of the aperture plate 100 must be extremely small, there is a case in which a diffraction phenomenon occurs because of its small opening. In such an image sensing condition, it is proper to use the ND filter 36 capable of reducing intensity of light without changing a relative spectroscopy distribution of energy.

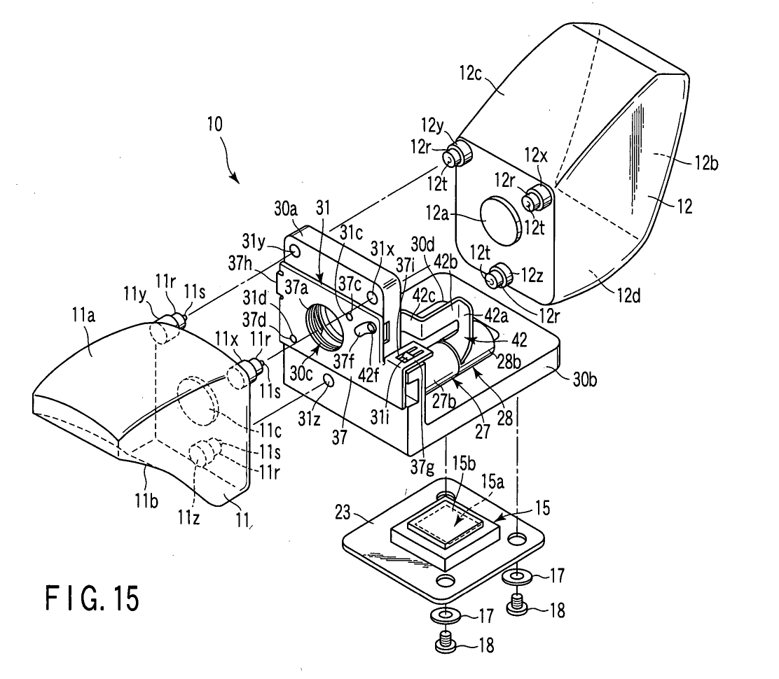

An image sensing device 10a according to a second embodiment of the present invention will be described with reference to FIG. 15 to FIG. 17. Like constituent elements having identical functions to those of the image sensing device 10 shown in the first embodiment are designated by like reference numerals. A duplicate description is not repeated here.

In the image sensing device 10a shown in FIG. 15, a second wall 30b extends from a first wall 30a to the second prism 12 side, and does not extend to the first prism 11 side. That is, a frame 30 is formed continuously in an L shape surrounding the second incident surface 12a side and the second emergent surface 12d side of the second prism 12. In addition, a substrate 23 on which an image sensing element 15 is mounted is formed in size corresponding to a substrate mount portion 30 provided on a second wall 30b.

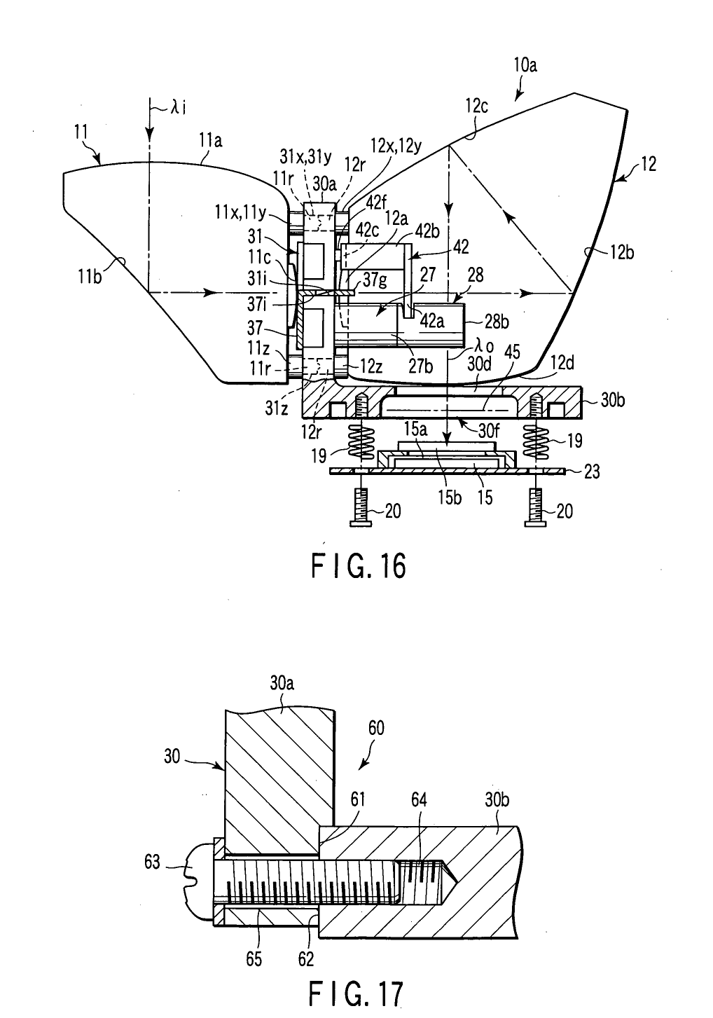

As shown in FIG. 16, the substrate 23 is held on a substrate mount portion 30f by an adjustment screw 20 in a state in which a coil spring 19 being one embodiment of an elastic member is sandwiched between the substrate and the substrate mount portion 30f. The substrate 23 is biased in a direction spaced from the substrate mount potion 30f by the coil spring 19. The location of a light-receiving surface 15a of the image sensing element 15 with respect to an image focusing surface 45 can be finely adjusted by adjusting a threading amount of the adjustment screw 20. Therefore, the light-receiving surface 15a can be easily positioned with respect to the image focusing surface 45.

Instead of the coil spring 19, a rubber sheet or a spring washer may be used as an elastic member. In addition, instead of providing the coil spring 19, the light-receiving surface 15a of the image sensing element 15 may be positioned and adjusted with respect to the image focusing surface 45 while the spacer 17 is sandwiched, in the same manner as in the first embodiment. The coil spring 19 or rubber sheet, a spring washer and the like may be used instead of the spacer 17 in the first embodiment.

In addition, in the second embodiment as well, the engagement portions 11x, 11y, 11z of the first prism 11 and the engagement portions 12x, 12y, 12z of the second prism 12 may be shaped in the embodiment as shown in FIG. 12A, FIG. 12B, FIG. 12C, and FIG. 12D, as shown in the first embodiment. In addition, the aperture plate 100 shown in FIG. 14 may be provided instead of providing the ND filter 36.

Further, with respect to the frame 30 in an embodiment in which the first wall 30a and the second wall 30b are composed of another member, respectively, a configuration of these joint portions 60 is shown in FIG. 17 in an enlarged manner. As shown in FIG. 17, the first wall 30a has an abutment portion 61 facing the second prism 12 side. A screw hole 64 spirally fitted with the fixing screw 63 is provided on an end face 62 of the second wall 30b facing the first prism 11. A screw through hole 65 through which the fixing screw 63 is inserted is provided at an abutment portion 61 of the first wall 30a corresponding to the screw hole 64 in a state in which the abutment portion 61 of the first wall 30a and the end face 62 of the second wall 30b are abutted against each other.

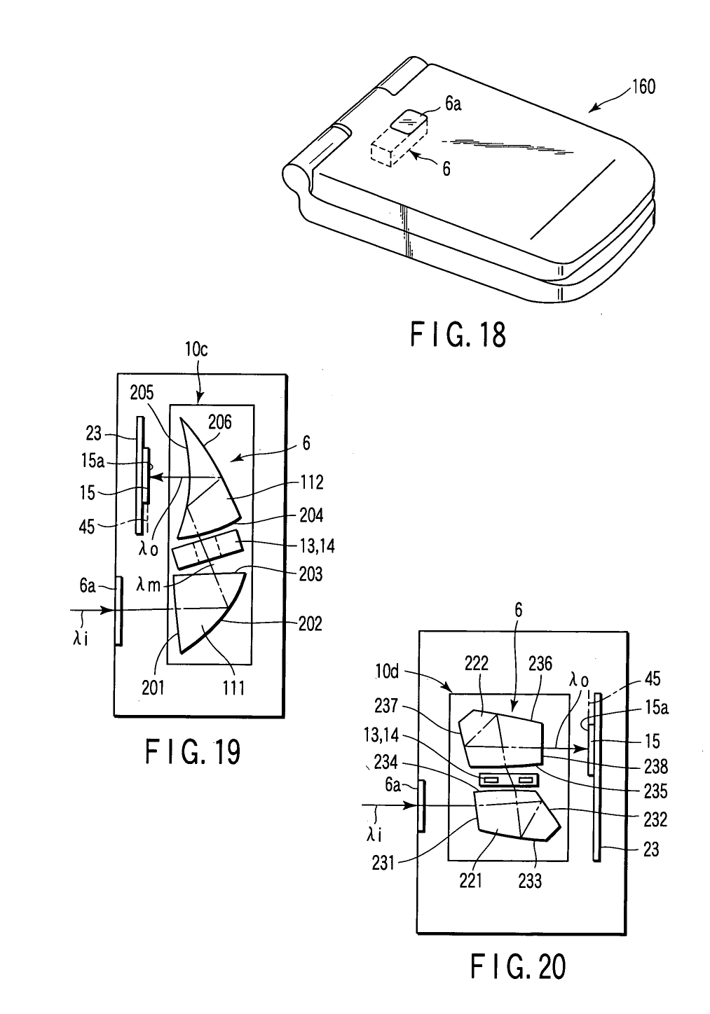

FIG. 18 shows an example of incorporating an image sensing unit in a cellular phone 160 with a camera as an example of an image sensing apparatus according to the present embodiment. In this cellular phone 160 with a camera, the image sensing device (for example, image sensing device 10) explained in the embodiments each described previously is incorporated as an image sensing optical system 6, thereby making it possible to compactly and thinly produce the cellular phone 160 with a camera and produce an image with high quality.

FIG. 19 and FIG. 20 show an example in which a different image sensing device is applied to the image sensing apparatus according to the present invention respectively.

In the image sensing device 10c shown in FIG. 19, the first prism 111 and the second prism 112 are composed of surfaces 201 to 206, each of which is fully formed on a free-form surface, respectively. The luminous flux λ1 incident from the first surface 201 is diffracted on a first surface 201, the diffracted luminous flux is fully reflected on a second surface 202, and then the fully reflected luminous flux is diffracted on and emerged from a third surface 203. The luminous flux λm emerged from the first prism 111 is made incident and diffracted at a fourth surface 204, the diffracted luminous flux is fully reflected on a fifth surface 205 and a sixth surface 206, and then the fully reflected luminous flux is diffracted and emerged on the fifth surface 205. The luminous flux λo emerged from the second prism 112 is focused as an image on the image focusing surface 45.

In an image sensing device 10d shown in FIG. 20, a first prism 221 and a second prism 222 are composed of surfaces 231 to 238 fully formed on a free-form surface. The luminous flux λi incident from a first surface 231 is diffracted on the first surface 231, and the diffracted luminous flux is fully reflected on a second face 232 and a third face 233. Then, the fully reflected luminous flux is diffracted on a fourth surface 234, and is emerged wherefrom. The luminous flux emerged from the first prism 221 is incident to a fifth surface 235 of the second prism 222, and is diffracted there. The diffracted luminous flux is fully reflected on a sixth surface 236 and a seventh surface 237, and then the fully reflected luminous flux is diffracted on an eighth surface 238, and is emerged wherefrom. The luminous flux λo emerged from the second prism 222 is focused as an image on the image focusing surface 45.

When carrying out the present invention, of course, constituent elements of the invention including a prism optical system or an image sensing element can be variously modified and carried out without deviating the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the inventive as defined by the appended claims and their equivalents thereof.

1. An image sensing device comprising:
a first prism receiving at a first incident surface a luminous flux radiated from an object, and outputting the luminous flux at a first emergent surface after reflecting the luminous flux on at least one of a first reflecting surface formed in the shape of free-form surface;
a second prism receiving at a second incident surface the luminous flux emerged from the first emergent surface, and outputting the luminous flux at a second emergent surface after reflecting the luminous flux on at least one of a second reflecting surface formed in a shape of a free-form surface;
a shutter mechanism arranged between the first emergent surface and the second incident surface; and
an image sensing element arranged on an image focusing surface of an optical system including the first prism and the second prism, said image sensing element converting an object image formed by the optical system into an electrical signal.

2. The image sensing device according to claim 1, wherein the shutter mechanism includes shutter blades to be selectively switched to either of an open state in which the luminous flux emerging from the first emergent surface is passed toward the second incident surface and a closed state in which the luminous flux emerging from the first emergent surface is interrupted.

3. The image sensing device according to claim 1, wherein the shutter mechanism has at least two shutter blades moving together, and the shutter blades are selectively switched to either of an open state in which the luminous flux emerging from the first emergent surface is passed toward the second incident surface and a closed state in which the luminous flux emerging from the first emergent surface is interrupted.

4. The image sensing device according to claim 3, wherein the shutter mechanism includes a blade drive mechanism which moves and holds the shutter blades in a direction crossing the luminous flux emerging from the first emergent surface, and the blade drive mechanism moves the shutter blades in a range between the closed state and the open state, thereby changing a size of an opening formed by the shutter blades.

5. An image sensing device according to claim 1, further comprising:
an aperture having an opening smaller than an external diameter of the luminous flux emerging from the first emergent surface, said aperture being arranged between the first emergent surface and the second incident surface.

6. The image sensing device according to claim 5, wherein the aperture is selectively held at either one of an insert position crossing the luminous flux emerging from the first emergent surface between the first emergent surface and the second incident surface and a retracted position deviated from the luminous flux.

7. The image sensing device according to claim 6, wherein the aperture is such that a center of the opening is arranged coaxially to a center axis of the luminous flux at the insert position.

8. The image sensing device according to claim 6, wherein the aperture is provided in the shutter mechanism.

9. An image sensing device according to claim 1, further comprising:
a light reducing filter reducing an amount of light, and being arranged between the first prism and the second prism,
wherein the light reducing filter is selectively held at either of an insert position crossing the luminous flux emerging from the first emergent surface and the retracted position deviated from the luminous flux extending between the first emergent surface and the second incident surface.

10. The image sensing device according to claim 1, wherein the first prism and the second prism include an engagement portion for holding a mutual relative position.

11. The image sensing device according to claim 10, wherein the engagement portion provided at the first prism side and the engagement portion provided at the second prism side are directly engaged with each other.

12. An image sensing device according to claim 1, further comprising:
a frame holding the first prism, the second prism, the shutter mechanism and the image sensing element in a specific positional relation.

13. The image sensing device according to claim 12, wherein the frame has:
a first wall which positions and holds the shutter mechanism between the first prism and the second prism; and
a second wall which positions and holds the image sensing element on the image focusing surface.

14. The image sensing device according to claim 13, wherein the first wall and the second wall are integrally formed.

15. An image sensing apparatus comprising:
a first prism receiving at a first incident surface a luminous flux radiated from an object, and outputting the luminous flux at a first emergent surface after reflecting the luminous flux on at least one of a first reflecting surface formed in a shape of free-form surface;
a second prism receiving at a second incident surface the luminous flux emerging from the first emergent surface, and outputting the luminous flux at a second emergent surface after reflecting the luminous flux on at least one of a second reflecting surface formed in a shape of free-form surface;
a shutter mechanism arranged between the first emergent surface and the second incident surface;
an image sensing element arranged on an image focusing surface of an optical system including the first prism and the second prism, said image sensing element converting an object image formed by the optical system into an electrical signal;
processing means to execute predetermined electrical processing to an electrical signal obtained by the image sensing element, thereby obtaining image data; and
recording means to record the image data from the processing means in an applied information recording medium.
